(19) United States
(12) Patent Application Publication
(10) Pub. No.: US 2014/0244921 A1
(43) Pub. Date: Aug. 28, 2014

(54) ASYMMETRIC MULTITHREADED FIFO MEMORY

(71) Applicant: NVIDIA CORPORATION, Santa Clara, CA (US)

(72) Inventors: Robert A. Alfieri, Chapel Hill, NC (US); Akshay Sood, New Delhi (IN)

(73) Assignee: NVIDIA CORPORATION, Santa Clara, CA (US)

(21) Appl. No.: 13/778,002

(22) Filed: Feb. 26, 2013

(51) Int. Cl. G06F 3/06

(52) U.S. Cl. CPC G06F 3/0656
USPC 711/104

(57) ABSTRACT

A First-in First-out (FIFO) memory comprising a latch array and a RAM array and operable to buffer data for multiple threads. Each array is partitioned into multiple sections, and each array comprises a section designated to buffer data for a respective thread. A respective latch array section is assigned higher priority to receive data for a respective thread than the corresponding RAM array section. Incoming data for the respective thread are pushed into the corresponding latch array section while it has vacancies. Upon the latch array section becoming empty, incoming data are pushed into the corresponding RAM array section during a spill-over period. The RAM array section may comprise two spill regions with only one active to receive data at a spill-over period. The allocation of data among the latch array and the spill regions of the RAM array can be transparent to external logic.

### CROSS REFERENCE

The present disclosure is related to: the co-pending patent application titled, “ASYMMETRIC FIFO MEMORY,” filed on Nov. 8, 2012 and Ser. No. 13/672,596; a U.S. patent titled, “MULTI-THREAD FIFO MEMORY GENERATOR,” U.S. Pat. No. 7,630,389; and a U.S. patent titled, “MULTITHREADED FIFO MEMORY WITH SPECULATIVE READ AND WRITE CAPABILITY,” U.S. Pat. No. 8,201,172. The foregoing related patent application and patents are herein incorporated by reference.

### TECHNICAL FIELD

The present disclosure relates generally to the field of data storage, and, more specifically, to the field of First-in First-out (FIFO) memory.

### BACKGROUND

In integrated circuits designed to process data, First-in First-out (FIFO) memories are typically used to store data between processing states. In hardware form, a FIFO primarily consists of a set of read and write pointers, storage and control logic. The storage may be based on RAM cells in one example or built-in logic storage in another example, such as flip-flops or latches, or any other suitable form of storage elements.

In multithreaded processing systems, it is important that data for each thread can be accessed independently from data for another thread because during multithreaded processing, each thread may be executed at a different rate and data may be pushed in or drained from the FIFOs in a different rate. Conventionally, a FIFO memory in such system typically is dedicated to buffer data for a single processing thread to avoid interference between threads. However, using multiple FIFOs inevitably requires increasing die area, which does not fit in the area optimization scheme in IC designs.

Another issue with FIFO designs lies in that, in a conventional FIFO generator that produces synthesizable code, FIFO designs are optimized by area and not so much by power. RAM arrays provide the benefit of large storage capacity. However, they are usually placed on the boundary of the IC partition and unfortunately typically far away from the logic that uses the storage. Thus, data transmission to and from RAM cells consumes relatively high dynamic power through the long interconnect paths from the using logic to the RAM cells. Also, a RAM array itself may have long internal paths, further contributing to high dynamic power consumption. In contrast, flip-flops or latches are built into or near the using logic and have relatively short interconnect and internal paths. Thus they provide the advantages of lower dynamic power consumption and faster speed, but usually are not used in large volume storage because they consume large areas and are expensive.

Medium to large FIFOs usually use RAM cells to provide large capacities for the worse storage requirements. However, it is observed that these FIFOs are often empty or near empty in many periods, e.g. 70% of the working time they may be empty or near empty.

### SUMMARY OF THE INVENTION

It would be advantageous to provide a multithreaded FIFO memory that consumes reduced dynamic power as well as reduced die area. It would also be advantageous to provide a generator that is capable of producing synthesizable code for such a FIFO memory.

Accordingly, embodiments of the present disclosure provide an asymmetric FIFO memory comprising a built-in logic storage array, e.g. latches or flip-flops, and a RAM array and consuming reduced dynamic power. The RAM may be located along the IC boundaries while the latch array is disposed close to the logic that uses the FIFO. Embodiments of the present disclosure advantageously include a mechanism to alternate the data entry between the two constituent arrays (a built-in logic storage array and a RAM array) with maximized usage of the built-in logic storage array and without introducing complication of the logic that uses the FIFO. Each of the constituent arrays is divided into a plurality of sections, each section responsible for buffering data for a respective thread. Thereby data for different sections can be independently accessed and associated using logic may use the FIFO memory as if there is separate FIFO for each thread.

In one embodiment of present disclosure, a FIFO operable to buffer data for multiple threads comprises an input to receive data, a first memory block comprising a plurality of sequential logic storage units, a second memory block comprising a plurality of RAM cells, control logic, and an output configured to drain data. Each of the first and the second memory blocks is divided into a plurality of sections. Thus, each memory block comprises a section designated to buffer data for a respective thread. The control logic is configured to control the usage of the FIFO. Data for a respective thread are pushed into a corresponding section of the first memory block if this corresponding section contains vacancies until it becomes full. When it becomes full, pushing data for the same thread to the corresponding section of the second memory block during a corresponding spill-over period until the corresponding section of the first memory block becomes empty, and then using the corresponding section of the first memory block for buffering subsequent incoming data for this thread. Data for this thread are drained in accordance with the entry order thereof. The storage capacity assigned to a respective section in either memory block may be reconfigurable upon the FIFO memory being empty. The first memory block may comprise a plurality of latches or flip-flops or a combination thereof. The first memory block may comprise less storage capacity than the second memory block. The first memory block may comprise one or more latch arrays, with each designated to a respective thread. A section of the second memory block may comprise two spill regions. During a corresponding spill-over period, data may be pushed to the first spill region until the corresponding section of first memory block is empty. Upon the corresponding section of first memory block becoming full, and when the first spill region is not empty, data are pushed to the second spill region until the corresponding section of first memory block is empty.

In another embodiment of present disclosure, a method for buffering data for multiple execution thread using a FIFO memory comprises: a) buffering data for a first execution thread to and from a first segment of a first memory block while the first segment has vacancies; b) upon the first segment of the first memory block becoming full, buffering data for the first execution thread to a first spill region of a first portion of a second memory block during a corresponding spill-over period; c) during the corresponding spill-over period, buffering data for the first execution thread to the first spill region of the first portion of the second memory block until the first segment of the first memory block becoming empty; and d) during b) and c) draining data for the first execution thread out of the first and second memory blocks in accordance with a storage order thereof. The method may further comprise buffering data for the first execution thread to the second spill region of the second memory block during the corresponding spill-over period upon the first segment of the first memory block being full and the first spill region of the first portion being not empty.

In another embodiment of present disclosure, a computer readable non-transient storage medium storing instructions for causing a processor to produce synthesizable code representing a FIFO memory by performing the operations of: 1) obtaining configuration input from a user; 2) generating synthesizable code representing an input operable to receive data; 3) generating synthesizable code representing a first memory block comprising a plurality of memory segments, each comprising a plurality of latches and/or flip-flops; 4) generating synthesizable code representing a second memory block comprising a plurality of RAM sections, each comprising a plurality of RAM cells; 5) generating synthesizable code representing logic coupled with and configurable to control usage of the first memory block and the second memory block. The logic is operable to perform a method comprising: a) buffering data for a respective execution thread to and from a respective memory segment of the first memory block while the respective memory segment has vacancies; b) upon the respective memory segment of the first memory block becoming full, buffering data for the respective execution thread to and from a first spill region of a respective RAM section of the second memory block until the respective memory segment of the first memory block becoming empty; and c) draining data for the respective execution thread out of the first and second memory blocks in accordance with a storage order thereof. The logic may further buffer data for a thread to a second spill region of the RAM section upon the memory segment of the first memory block becoming full and when the first spill region is not empty. The first spill region and the second spill region may merge upon the first spill region becoming empty.

This summary contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1 illustrates a block diagram of a partial integrated circuit that comprises an asymmetric multithreaded FIFO memory in accordance with an embodiment of the present disclosure.

FIG. 2 illustrates a block diagram of an asymmetric multithreaded FIFO memory with a shared latch array in accordance with an embodiment of the present disclosure.

FIG. 3 illustrates a block diagram of an asymmetric multithreaded FIFO memory with dedicated latch arrays in accordance with an embodiment of the present disclosure.

FIG. 4 is a flow diagram illustrating an exemplary multithread data allocation method in the asymmetric FIFO memory during a buffering process in accordance with an embodiment of the present disclosure where the RAM array has one spill region.

FIG. 5 is a flow diagram illustrating an exemplary multithread data allocation method in an asymmetric multithreaded FIFO during a buffering process in accordance with an embodiment of the present disclosure where a section of the RAM array comprises two spill regions.

FIGS. 6a, 6b, 6c, 6d, 6e, 6f, 6g, and 6h are state diagrams illustrating a sequence of exemplary data buffering processes in an asymmetric multithreaded FIFO memory in accordance with an embodiment of the present disclosure.

FIG. 7 illustrates a block diagram of a computing system including a synthesized code generator in accordance with an embodiment of the present disclosure.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### Notation and Nomenclature:

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or display devices. When a component appears in several embodiments, the use of the same reference numeral signifies that the component is the same component as illustrated in the original embodiment.

### Asymmetric Multithreaded FIFO Memory

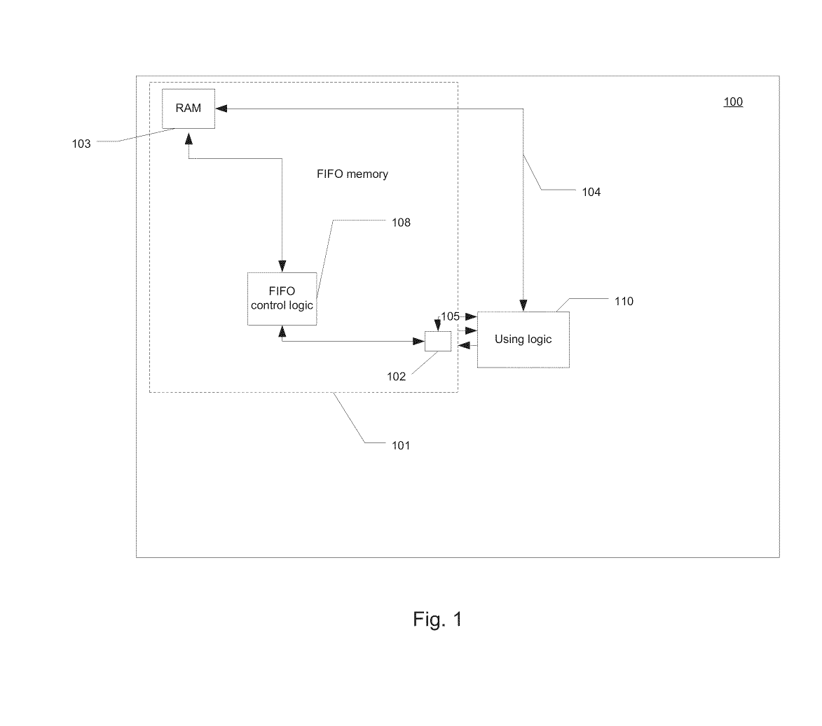

FIG. 1 illustrates a block diagram of a partial integrated circuit 100 that comprises an asymmetric multithreaded FIFO memory 101 in accordance with an embodiment of the present disclosure. The integrated circuit 100 comprises a “using logic” 110 that produces and consumes a stream of buffered data, and an asymmetric multithreaded FIFO memory 101 including a latch or flip-flop array 102, a RAM array 103, and FIFO control logic 108. The using logic can be any multithreaded system, or multiple systems that includes both a single threaded system and a multithreaded system, e.g. an imaging processing system, graphic display system, audio playback system, data compressing/decompressing system, or any other types of digital integrated circuits. Data from different threads of one or more systems may share the physical space, in part or in whole, of the FIFO memory 101, while still can be accessed independently.

As shown in FIG. 1, the latch array 102 is disposed in the vicinity of, or within, the using logic 110 and thus communicates with the using logic with short interconnect lines 105. The RAM array 103 on the other hand is disposed at the edge of a partition and distant from the using logic 110, and communicates with the using logic on long interconnect wires 104.

As described further below, in accordance with embodiments of the present disclosure, a designated section of the latch array 102 can be used predominantly to buffer data for a particular thread when available to store data, and a section designated to the same thread in the RAM array 103 can be used during spill-over periods when the designated section in the latch array 102 is full. Thus, controlled by the FIFO control logic 108, data flow from a certain thread remains in the sections designated to this thread in all the associated arrays, namely 102 and 103, while the availability of sections designated for other threads may be irrelevant. The control logic 108 may make this sharing between the RAM array 103 and the latch array 102 completely transparent to the using logic 110.

Although for purposes of illustration, the asymmetric multithreaded FIFO 101 is described to contain only one latch array and one RAM array, there is no limit on the number of either type of array that the FIFO 101 may comprise in order to implement this disclosure. In some embodiments, the latch array 102 can be replaced with a flip-flop array or combined with a flip-flop array, as flip-flops share the advantage of consuming relatively low dynamic power.

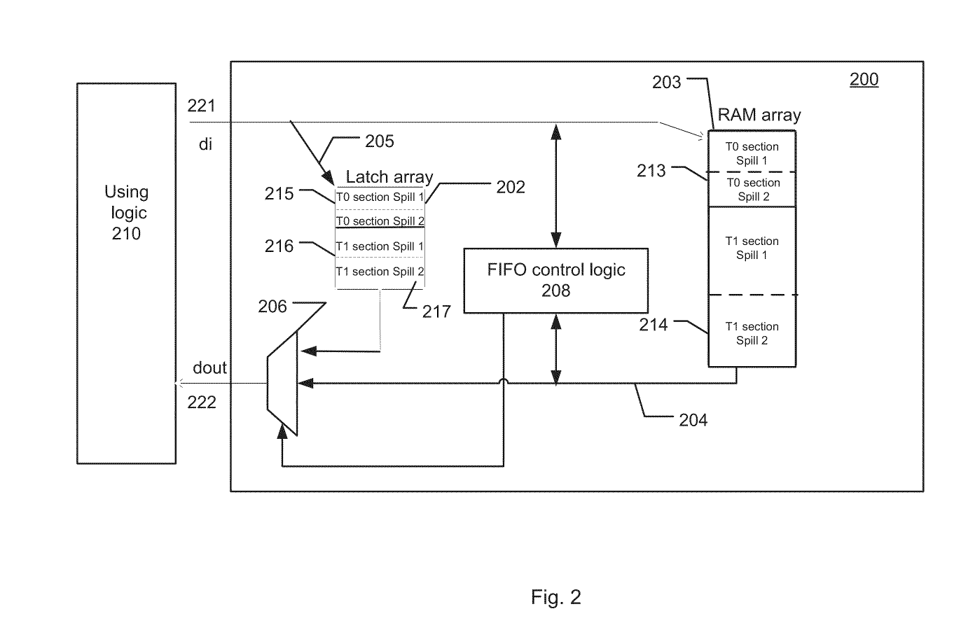

FIG. 2 illustrates a block diagram of an asymmetric multithreaded FIFO memory 200 with a shared latch array in accordance with an embodiment of the present disclosure. The asymmetric multithreaded FIFO 200 comprises an input 221, an output 222 coupled to a Multiplexer (MUX) 206, a latch array 202, a RAM array 203, and FIFO control logic 208. Using logic 210 is coupled with the FIFO 200 through the input 221 and output port 222. The using logic comprises multiple processing threads including T0 and T1. The FIFO 200 serves to buffer data for the named two threads.

Each storage array, 202 and 203, is divided into two sections, T0 section and T1 section, with each section responsible for buffering data for a respective thread. A section of the latch array 202 can be used predominantly to buffer data for a particular thread when available to store data, and a RAM section designated to the same thread can be used during spill-over periods for data from this thread when the corresponding latch array section is full.

In some embodiments, each section in the FIFO 200 may have a different storage capacity, e.g., depending on the estimated data flow for a corresponding thread. In some embodiments, the addresses allocated for each thread may be reconfigurable by a user. In some embodiments, this reconfiguration may be permitted only when both arrays, 202 and 203, are empty. In some other embodiments, the addresses allocated for each thread may be dynamically changed.

The FIFO control logic 208 may operate to combine the latch array 202 and the RAM array 203 into an asymmetric multithreaded FIFO memory 200 which buffers the data for two threads of the using logic 210. Incoming data can be received at the input 212 sequentially, pushed and stored into appropriate sections in accordance with the method described above. The FIFO control logic 208 disclosed herein can be implemented as a circuit, an application program or a combination of both.

The stored data from a respective thread can later be read, or consumed, by that thread of the using logic 210 through the output 222 and the MUX 206 in the same order as being pushed in. The sections designated for a respective thread have a separate counter from other sections. Thereby, data for each thread can be accessed independently, as if each thread has a dedicated FIFO memory.

Internally, the FIFO control logic 208 can operate to manage and control the flow of data associated with a certain thread and allocate an incoming data to a corresponding section in either the latch array 202 or the RAM array 203 based on the status of the two arrays. The control logic 208 may identify the source thread of an incoming data by a thread ID associated with the data. Data for T0 remain in T0 section 215 in the latch array 202 and the T0 section 213 in the RAM array 203. Likewise, data for T1 remain in T1 section 216 and 214. To make efficient use of the latch array 202 which typically consumes much less dynamic power than the RAM array 203, each section the latch array 202 is assigned with higher use priority to receive data than a corresponding section in the RAM array 203.

The allocation of the data among the sections inside the asymmetric FIFO 200, can be transparent to the using logic 210, as well as any other logic that communicates with the asymmetric FIFO 200. Moreover, the using logic 210 may only see a FIFO memory 200 having one input and one output without regards to the asymmetric FIFO's 200 internal allocation mechanism.

In some embodiments, a section in a RAM array may only be configured as one spill region. Once a section for a thread in the latch array 202 is full, the subsequent incoming data from the particular thread is pushed into the RAM array section. For example, once T0 section 215 in the latch array 202 is full, data from thread T0 is pushed into T0 section 213 of the RAM array 203 until the latch array section 215 is empty again. In some embodiments, especially those that employ less complicated FIFO control logic to keep track of the ordering of data for economical purposes, data writing operations for a particular thread is put off until the spill region in the RAM array is determined to be completely drained. Thus, in order to further maximize the usage of the latch array, two or more spill regions can be allowed in the RAM array.

In the illustrated embodiment, each section in the RAM array, 213 and 214, is further divided into two spill regions. Data from, e.g., thread T0 is pushed into T0 section 215 in the latch array 202 until it is full. Subsequent T0 data is pushed into T0 spill region 1 in the RAM array 203 until the T0 section 215 in the latch array 202 is empty. When the section 215 is full again and when spill region 1 of the T0 section is not empty, subsequent data is pushed into spill region 2 of the T0 section. Thereby, the FIFO memory as well as the latch array is used more frequently and efficiently.

In some other embodiments, a section for a RAM array can have two or even more spill regions. In some embodiments, the spill regions can be fixed partitions of a RAM array section; while in some others, they can be dynamic partitions of a section of the RAM array 203.

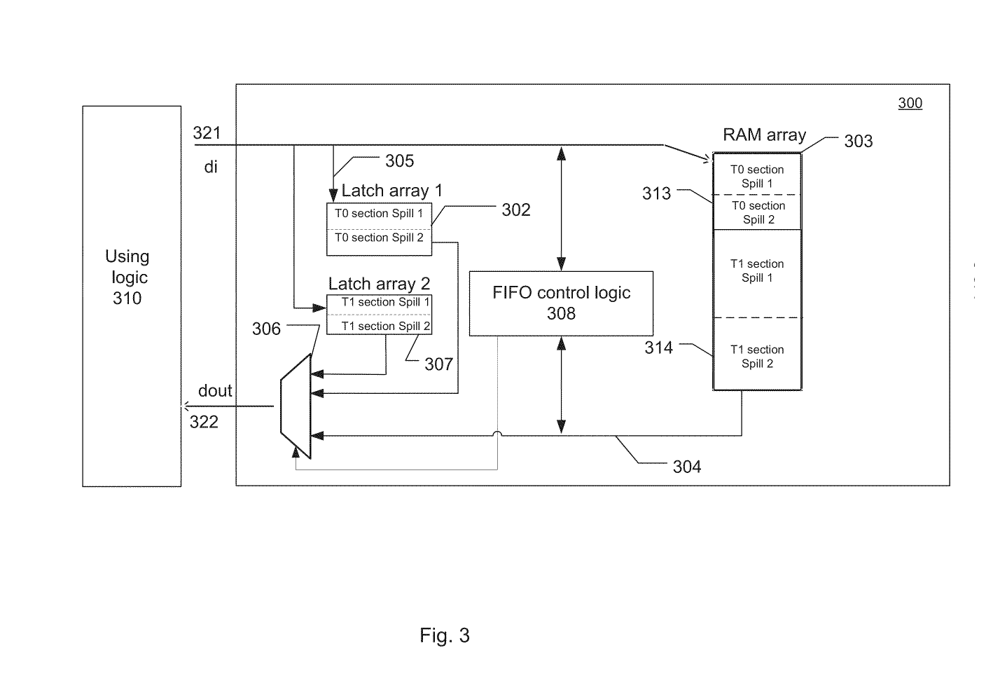

In some embodiments, similar with the RAM array, one or more spill regions can be created in a latch array section. In the illustrated embodiments in FIG. 2 and FIG. 3, each section of the latch array is portioned into two spill region. The spill regions can be used to receive data when a corresponding RAM array section becomes full before the corresponding latch array section is empty. Thus, upon the RAM array section becoming full, subsequent data for the particular thread can be pushed into a spill region of the latch array section so long as the latch array section has vacancies. Thereby, the usage efficiency of the latch array as well as the FIFO memory can be further improved.

For purposes of practicing the embodiments of the present disclosure, there are no particular requirements on the width or the depth of each array or each section of an individual array, nor are there limitations on the number of threads associated with the multithreaded FIFO memory.

In some embodiments, the asymmetric multithreaded FIFO memory 200 can be configured to be a programmable FIFO capable of performing specific operations on the buffered data before the data are output. Further, in some embodiments, the asymmetric FIFO memory 200 can be configured as a synchronous memory.

In some embodiments, the multithreaded FIFO memory may comprise more than one set of read and write port with each set responsible for data ingression and egression for a separate thread or section. In this manner, data for different threads may be accessed concurrently as well as independently. For example, at a certain moment, T0 section in the latch array can be read while T1 section in the RAM array is being read.

FIG. 3 illustrates a block diagram of an asymmetric multithreaded FIFO memory 300 with dedicated latch arrays in accordance with an embodiment of the present disclosure. The FIFO 300 has a similar configuration with the embodiment illustrated in FIG. 2. The components in the FIFO 300 have similar functions with their counterparts in FIG. 2. FIFO 300 differ from FIFO 200 in that two latch arrays, 302 and 307, are included and each can be dedicated to buffer data for a separate set of threads. In the applications where one set of threads had significantly larger data flow than the other, this embodiment may further reduce dynamic power consumed by the FIFO. In the illustrated example, each latch array is dedicated to one thread. As the capacity of each latch array is fixed, storage spaces assigned to each set of latch array sections may remain fixed. However, as each of the latch arrays can be partitioned into section, partitions within each latch array may still be reconfigurable.

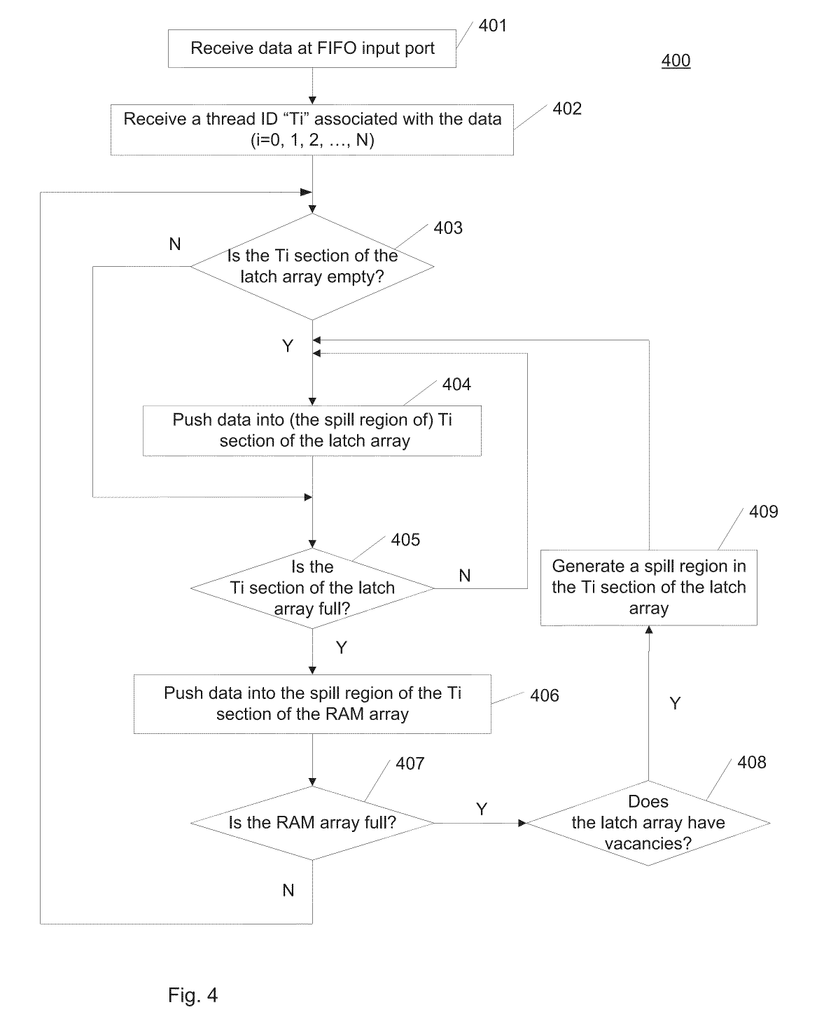

FIG. 4 is a flow diagram illustrating an exemplary multithread data allocation method 400 in the asymmetric FIFO memory during a buffering process in accordance with an embodiment of the present disclosure where the RAM array has one spill region. The FIFO memory as well as its components referred to herein may have similar functions and configurations as the illustrated embodiments in FIG. 2 and FIG. 3 unless otherwise specified. At 401, the input of the asymmetric multithreaded FIFO receives a stream of incoming data at the start. At 402, a thread ID Ti (i=0, 1, 2, . . . , N) associated with each incoming data is received. For each data in the stream, if control logic determines the Ti section of the latch array is empty at 403, the data is pushed into the Ti section of the latch array at 404 and later consumed (not explicitly shown), until it is determined that the latch array is full at block 405. If the Ti section of the latch array becomes full at 405, subsequent data are pushed into the spill regions of the Ti section of the RAM array at 406 until the RAM array section becomes full at 407 or the Ti section of the latch array is empty again at 403 before the RAM array section is determined to be full at 407. If the Ti section of the latch array is determined to have vacancies at 408 when the Ti section of the RAM becomes full at 407, a spill region is created in the Ti section of the latch array at 409 to receive subsequent Ti data. The operations in foregoing blocks 402-409 are repeated for following incoming data.

An empty status may be declared when either no data has been stored in it or the stored data have all been consumed by a using circuit. In some other embodiments, the latch array can be defined as empty when a certain number of entries have been consumed. A full status may be declared when every entry has been written to and not consumed.

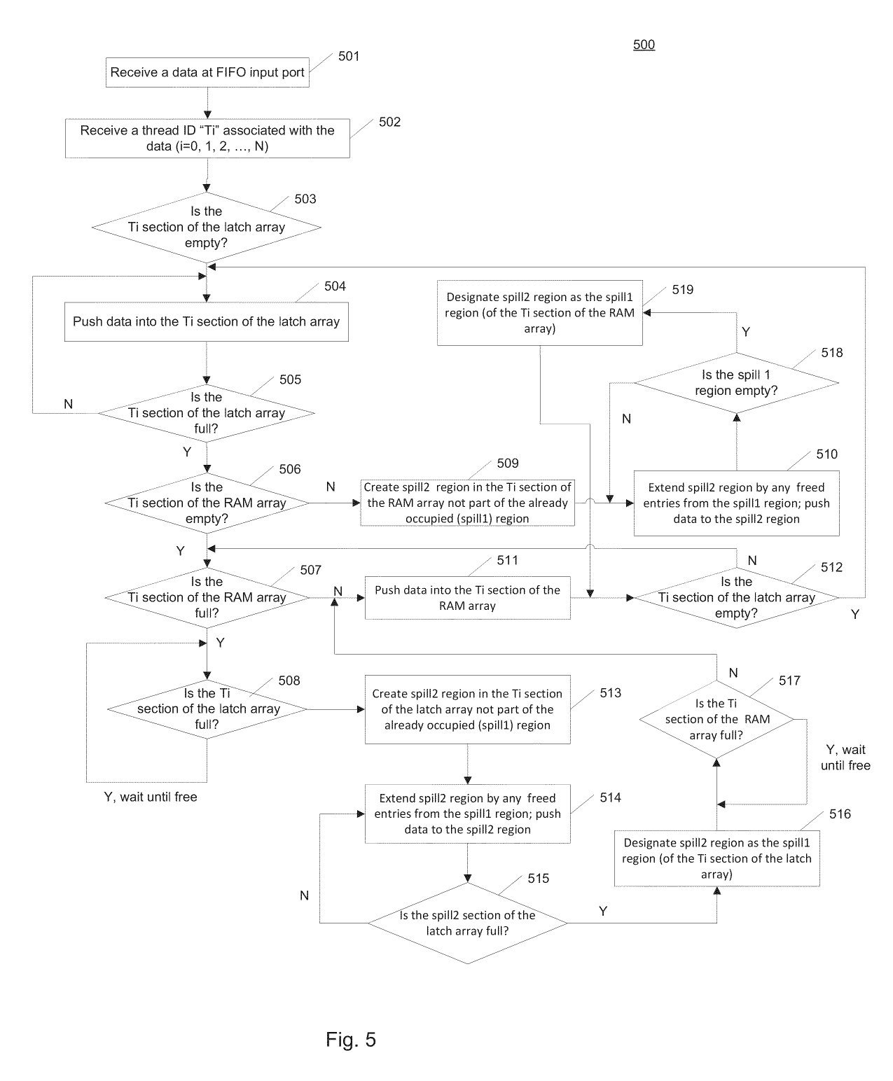

FIG. 5 is a flow diagram illustrating an exemplary multithread data allocation method 500 in an asymmetric multithreaded FIFO during a buffering process in accordance with an embodiment of the present disclosure where a section of the RAM array comprises two spill regions, e.g., spill region 1 and spill region 2. At 501, the input of the asymmetric FIFO receives a stream of data. At 502, a thread ID Ti (i=0, 1, 2, . . . , N) associated with each data that is received. For each data in the stream, the corresponding section, i.e., Ti section, in the latch array is evaluated at 503. If it is determined to be empty, the incoming Ti data are pushed into and consumed from the Ti section of the latch array as in block 504, until the latch section is determined to be full in block 505. If the Ti section of the latch array becomes full in block 505, the availability of the RAM array is evaluated at 506. If the Ti section of the RAM array has vacancies, a spill region 2 that is not part of an already occupied spill region 1 is created in the Ti section of the RAM array at 509. Subsequent data are pushed into the spill region 2 of the Ti section of the RAM array at 510 until the RAM section becomes full or the Ti section of the latch array becomes empty. Spill region 2 in the RAM section expands dynamically by any freed entries from the spill 1 region. Upon the spill region 1 becomes empty at 518, the two spill regions of the Ti section of the RAM array merge into spill region 1 at 519.

Upon the Ti section of the latch array becoming empty at 512, incoming Ti data are pushed to the Ti section of the latch array until the section becomes full, as shown in 504. If the Ti sections in both arrays are full, as determined in 507 and 508, it means the FIFO has no vacancies and incoming data have to wait until a space is freed. In the event that the Ti section of the RAM array becomes full at 507 while the Ti section of the latch array has vacancies, a spill region 2 that is not part of an already existed spill region 1 is created in the Ti section of the latch array at 513. Incoming data are pushed into the spill region 2 of Ti section of the latch array. Similarly with the spill regions of the RAM array, the spill region 2 of the latch section expands as data are consumed from the spill region 1 of the latch section (, or as the spill region 1 shrinks) of the latch array Ti section. Once the spill region 2 of the latch array Ti section is full at 515, spill region 2 becomes spill region 1 at 516. At this point, since the latch array Ti section becomes full, data are pushed into the Ti section of the RAM array if it has vacancies, as evaluated at 517. The foregoing steps are then repeated.

Since spill region 1 of Ti section of the RAM array may have to drain completely before Ti section of the latch array can drain again due to the entry ordering of the data, once the Ti section of the latch array is determined to be empty, in some embodiment, it can be determined automatically that spill region 1 of Ti section is empty and accordingly spill region 2 can become spill region 1. In other words, the assertion of an empty section of the latch array operates to trigger the merge of the spill regions.

In this embodiment, only one spill region remains active in one section to receive data at a time. Data can be pushed into the corresponding section of the latch array as soon as it is determined to be empty. However, in some other embodiments, more than one spill regions can be active in one section at a time.

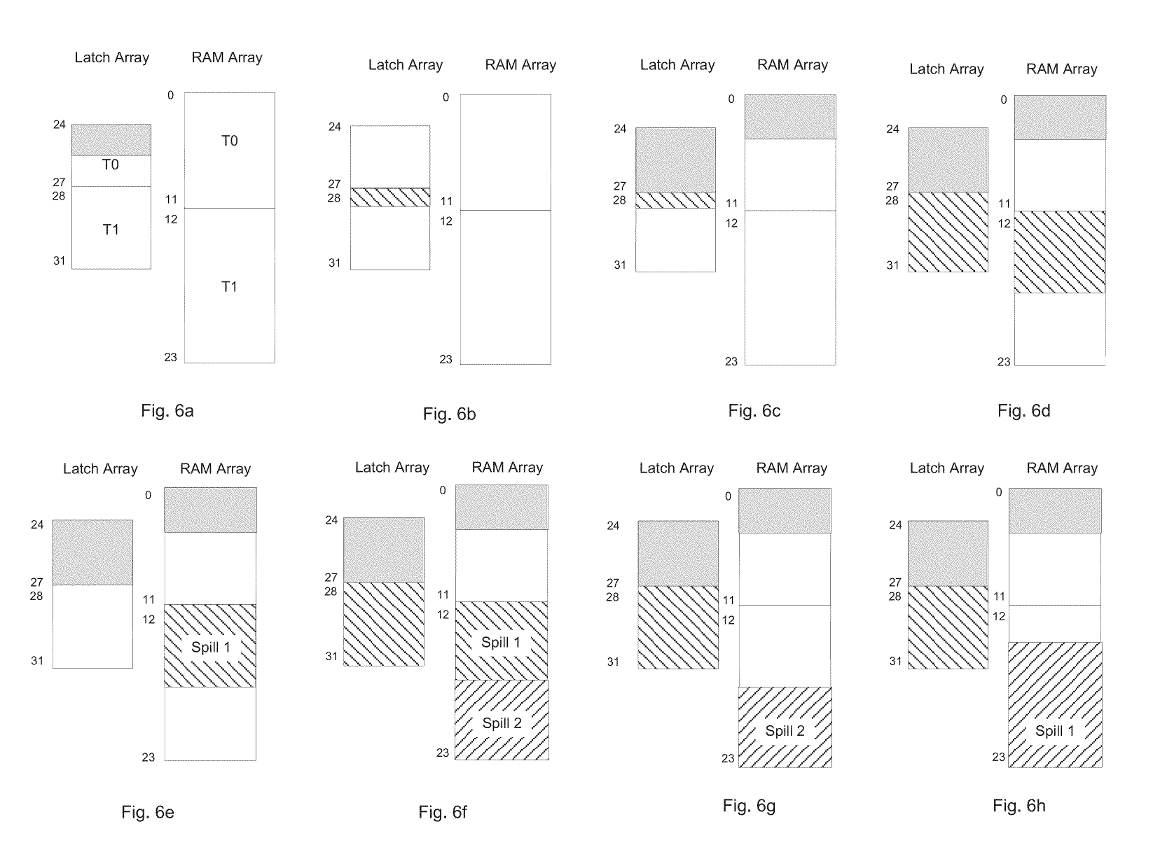

FIGS. 6a-6h are state diagrams illustrating a sequence of exemplary data buffering processes in an asymmetric multithreaded FIFO memory in accordance with an embodiment of the present disclosure. The latch array and the RAM array in FIGS. 6a-6h may have similar configurations as the latch array and the RAM array in FIG. 2 or FIG. 3, respectively. Each array is divided into two sections, T0 and T1, each section dedicated to buffer data for the stated thread. In the illustrated example, addresses 0˜11 are assigned to T0 section of the RAM array, 12˜23 are assigned to T1 section of the RAM array. 24˜27, and 28˜31 mark the T0 and T1 section of the latch array, respectively. The address allocation for individual arrays as well as individual threads is similarly exemplary only as far as the present disclosure is concerned.

Both arrays start as empty. In FIG. 6a, incoming data from thread T0 are pushed into and consumed from the T0 section of the latch array as in FIG. 6b. In FIG. 6b, it shows the thread T0 data stored in T0 section of the latch array has been consumed, and data for thread T1 are pushed into the T1 section of the latch array. Subsequently, as shown in FIG. 6c, the T0 section of the latch array becomes full, and additional T0 data are spilled to a spill region in T0 section of the RAM array; whereas T1 data stored in the latch array remain unconsumed. As more T1 data are received, FIG. 6d shows T1 section of the latch array is filled up with the T1 data, and the additional T1 data are allocated to a spill region of T1 section of the RAM array.

Since the T1 data stored in the latch array entered the asymmetric FIFO before those stored in the spill region at this point, the T1 section of the latch array is drained before the T1 section of the RAM array, as shown in FIG. 6e. Determination of an empty status of a section of the latch array can trigger the FIFO control logic to switch to using a corresponding section of the latch array from using the RAM array. Therefore subsequent data for thread T1 enter the latch array as shown in FIG. 6f. FIG. 6c˜FIG. 6e also demonstrate that although the T0 section of the latch array is filled up before the T1 section of the latch array, the T1 section of the latch array can be drained first due to the independence between the two threads.

When T1 section of the latch array is full again, FIG. 6f shows the scenario that the spill region 1 of T1 section still contains stored data not being consumed, or not drained. Subsequent data are pushed into spill region 2. Because the T1 data stored in spill region 1 of T1 section entered the FIFO before those stored in the T1 section latch array and the spill regions 2 array at this point, spill region 1 is drained first as FIG. 6g shows. Determination of an empty status of the spill region 1 may trigger the FIFO control logic to merge the two spill regions, and thereby spill region 2 can be redefined in the T1 section as spill region 1 as FIG. 6h shows.

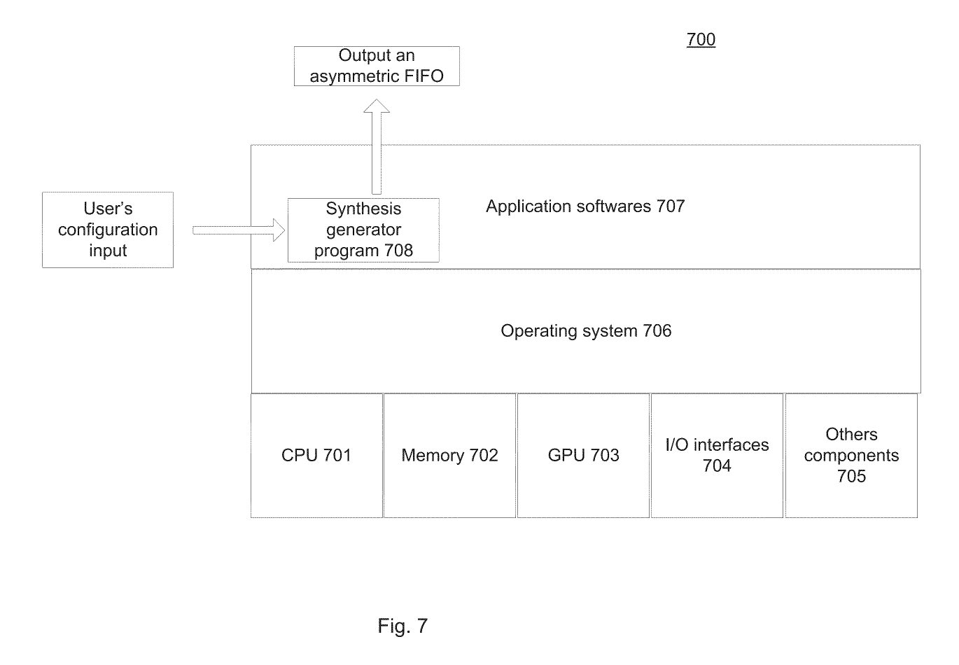

The asymmetric FIFO memory as well as associated circuitry disclosed herein can be produced automatically by a synthesizable code generator, such as VHDL, Verilog, or other hardware description languages known to those skilled in the art. FIG. 7 illustrates a block diagram of a computing system including a synthesizable code generator in accordance with an embodiment of the present disclosure. The computing system comprises a processor 701, a system memory 702, a GPU 703, I/O interfaces 704 and other components 705, an operating system 706 and application software 707 including a synthesis generator program 708 stored in the memory 702. When incorporating the user's configuration input and executed by the processor 701, the generator program 708 of the asymmetric FIFO memory produces a synthesizable code representing an asymmetric FIFO memory. The synthesizable code may be combined with other code, either produced by a generator program or authored by a programmer. Synthesizable code may be written in Verilog, VHDL, or other hardware description languages known to those skilled in the art.

The generator program comprises components that are used to produce corresponding components of synthesizable code, such as a RAM generator, an input port code generator and an output port interface code generator, and a FIFO generator (not shown). When executed by CPU, the storage code generator produces synthesizable storage code. Generally, the RAM generator code is used to synthesize or instantiate the storage resources within the asymmetric FIFO memory, e.g. flip flops, latches, RAM or the like. The FIFO generator provides an option to manually divide the asymmetric FIFO into a normal RAM array, for example, for the lower address and a sequential circuit or latch array for the upper addresses in accordance with those embodiments disclosed herein. The FIFO generator can lay down a RAM wrapper that looks like a normal RAM, but transparently handles the data flow among the constituent storage units within the FIFO as discussed within the embodiments of the present disclosure.

Table 1 is an exemplary synthesizable code of one multithreaded FIFO instance in accordance with an embodiment of the present disclosure.

```
TABLE 1
// vsplit ram for a multithreaded FIFO with 2 threads
module test1_vsplit_ram_rws_32×8_v4(
    clk
    , reset_{—}
    , we
    , di
    , re
    , dout
    , wr_pushing
    , rd_popping
    , wr_pushing_thread_id
    , rd_take_thread_id
    , wr_limit0
    , wr_limit_vsplit_latch_array0
    , wr_limit1
    , wr_limit_vsplit_latch_array1
    );
```

| | |
|---|---|
| input | clk; |
| input | reset_; |
| input | we; |
| input [7:0] | di; |
| input | re; |
| output [7:0] | dout; |
| input | wr_pushing; |
| input | rd_popping; |
| input | wr_pushing_thread_id; |
| input | rd_take_thread_id; |
| input [5:0] | wr_limit0; |
| input [5:0] | wr_limit_vsplit_latch_array0; |
| input [5:0] | wr_limit1; |
| input [5:0] | wr_limit_vsplit_latch_array1; |
| reg | rd_popping_thread_id; |

```
always @( posedge clk or negedge reset_{—} ) begin
    if ( !reset_{—} ) begin
        rd_popping_thread_id <= #0.01 1′d0;
    end else begin
        if ( re ) begin
            rd_popping_thread_id <= #0.01 rd_take_thread_id;
        end
        //synopsys translate_off
//VCS coverage off
            else if ( !re ) begin
        end else begin
            rd_popping_thread_id <= #0.01 {1{1′bx}};
        end
        //synopsys translate_on
//VCS coverage on
    end
end
```

| | |
|---|---|
| reg [4:0] | wr_adr; |
| wire [4:0] | wr_adr0; |
| wire [4:0] | wr_adr1; |

```
always @( wr_pushing_thread_id or
          wr_adr0 or
          wr_adr1 ) begin
    case( wr_pushing_thread_id ) // synopsys infer_mux
    1′d0: wr_adr = wr_adr0;
    1′d1: wr_adr = wr_adr1;
    // VCS coverage off
    default: wr_adr = {5{1′bx}};
    // VCS coverage on
    endcase
end
```

| | |
|---|---|
| reg [4:0] | rd_adr; |
| wire [4:0] | rd_adr0; |
| wire [4:0] | rd_adr1; |

```
always @( rd_take_thread_id or
          rd_adr0 or
          rd_adr1 ) begin
    case( rd_take_thread_id ) // synopsys infer_mux
    1′d0: rd_adr = rd_adr0;
    1′d1: rd_adr = rd_adr1;
    // VCS coverage off
    default: rd_adr = {5{1′bx}};
    // VCS coverage on
    endcase
end
```

| | |
|---|---|
| wire | wr_pushing0 = wr_pushing && wr_pushing_thread_id == 1′d0; |
| wire | rd_popping0 = rd_popping && rd_popping_thread_id == 1′d0; |
| reg | wr_large0; // writing to large ram right now? |
| reg | rd_large0; // reading from large ram right now? |
| wire | rd_large0_next; |
| wire | in_large0_write = wr_large0; // wr_enable same as wr_popping |
| wire | in_large0_read = rd_large0_next; // rd_adr/rd_enable lead rd_popping, so |

that rd_adr in current cycle (with rd_enable asserted) is popped out in a future cycle

| | |
|---|---|
| wire | wr_pushing0_small = ( !wr_large0 && wr_pushing0 ); |
| wire | wr_pushing0_large = ( wr_large0 && wr_pushing0 ); |
| wire | rd_popping0_small = ( !rd_large0 && rd_popping0 ); |
| wire | rd_popping0_large = ( rd_large0 && rd_popping0 ); |
| wire | small0_we = we && !in_large0_write && wr_pushing_thread_id == 1′d0; |
| reg [4:0] | small0_wa; |
| wire | small0_re = re && !in_large0_read && rd_take_thread_id == 1′d0; |
| reg [4:0] | small0_ra; |
| wire [4:0] | small0_ra_next; |
| wire [4:0] | small0_ra_p; |
| reg [4:0] | small0_adr_min; |
| reg [4:0] | small0_adr_max; |
| wire | large0_we = we && in_large0_write && wr_pushing_thread_id == 1′d0; |
| reg [4:0] | large0_wa; |
| wire | large0_re = re && in_large0_read && rd_take_thread_id == 1′d0; |
| reg | [4:0] large0_ra; |
| wire [4:0] | large0_ra_next; |
| wire [4:0] | large0_ra_p; |
| reg [4:0] | large0_adr_min; |
| reg [4:0] | large0_adr_max; |

```
always @( posedge clk ) begin
    small0_adr_min <= #0.01 5′d28;
    small0_adr_max <= #0.01 5′d28 + wr_limit_vsplit_latch_array0 − 5′d1;
    large0_adr_min <= #0.01 5′d0;
    large0_adr_max <= #0.01 5′d0 + wr_limit0 − wr_limit_vsplit_latch_array0 − 5′d1;
end
always @( posedge clk or negedge reset_{—} ) begin
    if ( !reset_{—} ) begin
        small0_wa <= #0.01 small0_adr_min;
        large0_wa <= #0.01 large0_adr_min;
    end else begin
        if ( small0_we ) begin
            small0_wa <= #0.01 ( small0_wa == small0_adr_max ) ? small0_adr_min : ( small0_wa
+ 1′d1 );
        end
            else if ( !small0_we ) begin
        end else begin
            small0_wa <= #0.01 {5{1′bx}};
        end
        if ( large0_we ) begin
            large0_wa <= #0.01 ( large0_wa == large0_adr_max ) ? large0_adr_min : ( large0_wa
+ 1′d1 );
        end
            else if ( !large0_we ) begin
        end else begin
            large0_wa <= #0.01 {5{1′bx}};
        end
    end
end
assign small0_ra_next = ( small0_ra == small0_adr_max ) ? small0_adr_min : ( small0_ra + 1′d1 );
assign small0_ra_p = rd_popping0_small ? small0_ra_next : small0_ra;
assign large0_ra_next = ( large0_ra == large0_adr_max ) ? large0_adr_min : ( large0_ra + 1′d1 );
assign large0_ra_p = rd_popping0_large ? large0_ra_next : large0_ra;
always @( posedge clk or negedge reset_{—} ) begin
    if ( !reset_{—} ) begin
        small0_ra <= #0.01 small0_adr_min;
        large0_ra <= #0.01 large0_adr_min;
    end else begin
        if ( rd_popping0_small ) begin
            small0_ra <= #0.01 small0_ra_next;
        end
            else if ( !rd_popping0_small ) begin
        end else begin
            small0_ra <= #0.01 {5{1′bx}};
        end
        if ( rd_popping0_large ) begin
            large0_ra <= #0.01 large0_ra_next;
        end
            else if ( !rd_popping0_large ) begin
        end else begin
            large0_ra <= #0.01 {5{1′bx}};
        end
    end
end
```

| | |
|---|---|
| wire | wr_pushing1 = wr_pushing && wr_pushing_thread_id == 1′d1; |
| wire | rd_popping1 = rd_popping && rd_popping_thread_id == 1′d1; |
| reg | wr_large1; // writing to large ram right now? |
| reg | rd_large1; // reading from large ram right now? |
| wire | rd_large1_next; |
| wire | in_large1_write = wr_large1; // wr_enable same as wr_popping |
| wire | in_large1_read = rd_large1_next; // rd_adr/rd_enable lead rd_popping, so |

that rd_adr in current cycle (with rd_enable asserted) is popped out in a future cycle

| | |
|---|---|
| wire | wr_pushing1_small = ( !wr_large1 && wr_pushing1 ); |
| wire | wr_pushing1_large = ( wr_large1 && wr_pushing1 ); |
| wire | rd_popping1_small = ( !rd_large1 && rd_popping1 ); |
| wire | rd_popping1_large = ( rd_large1 && rd_popping1 ); |
| wire | small1_we = we && !in_large1_write && wr_pushing_thread_id == 1′d1; |
| reg [4:0] | small1_wa; |
| wire | small1_re = re && !in_large1_read && rd_take_thread_id == 1′d1; |
| reg [4:0] | small1_ra; |
| wire [4:0] | small1_ra_next; |
| wire [4:0] | small1_ra_p; |
| reg [4:0] | small1_adr_min; |
| reg [4:0] | small1_adr_max; |
| wire | large1_we = we && in_large1_write && wr_pushing_thread_id == 1′d1; |
| reg [4:0] | large1_wa; |
| wire | large1_re = re && in_large1_read && rd_take_thread_id == 1′d1; |
| reg [4:0] | large1_ra; |
| wire [4:0] | large1_ra_next; |
| wire [4:0] | large1_ra_p; |
| reg [4:0] | large1_adr_min; |
| reg [4:0] | large1_adr_max; |

```
always @( posedge clk ) begin
    small1_adr_min <= #0.01 5′d28 + wr_limit_vsplit_latch_array0;
    small1_adr_max <= #0.01 5′d28 + wr_limit_vsplit_latch_array0 + wr_limit_vsplit_latch_array1 −
5′d1;
    large1_adr_min <= #0.01 5′d0 + wr_limit0 − wr_limit_vsplit_latch_array0;
    large1_adr_max <= #0.01 5′d0 + wr_limit0 − wr_limit_vsplit_latch_array0 + wr_limit1 −
wr_limit_vsplit_latch_array1 − 5′d1;
end
always @( posedge clk or negedge reset_{—} ) begin
    if ( !reset_{—} ) begin
        small1_wa <= #0.01 small1_adr_min;
        large1_wa <= #0.01 large1_adr_min;
    end else begin
        if ( small1_we ) begin
            small1_wa <= #0.01 ( small1_wa == small1_adr_max ) ? small1_adr_min : ( small1_wa
+ 1′d1 );
        end
            else if ( !small1_we ) begin
        end else begin
            small1_wa <= #0.01 {5{1′bx}};
        end
        if ( large1_we ) begin
            large1_wa <= #0.01 ( large1_wa == large1_adr_max ) ? large1_adr_min : ( large1_wa
+ 1′d1 );
        end
            else if ( !large1_we ) begin
        end else begin
            large1_wa <= #0.01 {5{1′bx}};
        end
    end
end
assign small1_ra_next = ( small1_ra == small1_adr_max ) ? small1_adr_min : ( small1_ra + 1′d1 );
assign small1_ra_p = rd_popping1_small ? small1_ra_next : small1_ra;
assign large1_ra_next = ( large1_ra == large1_adr_max ) ? large1_adr_min : ( large1_ra + 1′d1 );
assign large1_ra_p = rd_popping1_large ? large1_ra_next : large1_ra;
always @( posedge clk or negedge reset_{—} ) begin
    if ( !reset_{—} ) begin
        small1_ra <= #0.01 small1_adr_min;
        large1_ra <= #0.01 large1_adr_min;
    end else begin
        if ( rd_popping1_small ) begin
            small1_ra <= #0.01 small1_ra_next;
        end
            else if ( !rd_popping1_small ) begin
        end else begin
            small1_ra <= #0.01 {5{1′bx}};
        end
        if ( rd_popping1_large ) begin
            large1_ra <= #0.01 large1_ra_next;
        end
            else if ( !rd_popping1_large ) begin
        end else begin
            large1_ra <= #0.01 {5{1′bx}};
        end
    end
end
assign wr_adr0 = in_large0_write ? large0_wa : small0_wa;
assign rd_adr0 = in_large0_read ? large0_ra_p : small0_ra_p;
assign wr_adr1 = in_large1_write ? large1_wa : small1_wa;
assign rd_adr1 = in_large1_read ? large1_ra_p : small1_ra_p;
nv_ram_rws_32×8_v4_ram (
      .clk ( clk ) // only thing getting ungated clock
    , .we ( we )
    , .wa ( wr_adr )
    , .di ( di )
    , .re ( re )
    , .ra ( rd_adr )
    , .dout ( dout )
    );
reg [2:0] small0_used; // small ram entries in use
reg [2:0] small0_reads_pending; // small ram entries remaining to be read when switching write
pointer to large ram
reg [4:0] large0_used; // large ram entries in use
reg [4:0] large0_reads_pending; // large ram entries remaining to be read when switching write
pointer to small ram
wire [2:0] small0_used_next = small0_used + wr_pushing0_small − rd_popping0_small;
wire [4:0] large0_used_next = large0_used + wr_pushing0_large − rd_popping0_large;
wire [2:0] small0_depth = small0_adr_max − small0_adr_min + 5′d1;
wire [4:0] large0_depth = large0_adr_max − large0_adr_min + 5′d1;
wire switching_write_large_to_small0 = wr_large0 &&
                                      ( small0_used_next == 3′d0 || // small ram
got empty - spill2 case
                                      ( small0_used_next != small0_depth && // small
ram not full
                                          ( large0_used_next == large0_depth || // large
ram got full
                                            large0_used_next == 5′d0 ) // large ram
got empty
                                      )
                                    );
wire switching_write_small_to_large0 = !wr_large0 &&
                                    small0_used_next == small0_depth && large0_used_next !=
large0_depth; //
wire switching_read_large_to_small0 = rd_large0 &&
                                    ( large0_used_next == 5′d0 ||
                                    ( rd_popping0 && small0_reads_pending != 3′d0 &&
large0_reads_pending == 5′d1 ) ) ; // read out in write order
wire switching_read_small_to_large0 = !rd_large0 &&
                                    ( small0_used_next == 3′d0 && large0_used_next != 5′d0 ||
//
                                    ( rd_popping0 && small0_reads_pending == 3′d1 &&
large0_reads_pending != 5′d0 ) ); // read out in write order
assign rd_large0_next = !switching_read_large_to_small0 &&
                    ( switching_read_small_to_large0 || rd_large0 );
always @( posedge clk or negedge reset_{—} ) begin
    if ( !reset_{—} ) begin
        wr_large0 <= #0.01 1′b0;
        rd_large0 <= #0.01 1′b0;
    end else begin
        if ( switching_write_large_to_small0 ) begin
            wr_large0 <= #0.01 1′b0;
        end else if ( switching_write_small_to_large0 ) begin
            wr_large0 <= #0.01 1′b1;
        end
            else if ( !switching_write_large_to_small0 && !switching_write_small_to_large0 ) begin
        end else begin
            wr_large0 <= #0.01 {1{1′bx}};
        end
        if ( switching_read_large_to_small0 ) begin
            rd_large0 <= #0.01 1′b0;
        end else if ( switching_read_small_to_large0 ) begin
            rd_large0 <= #0.01 1′b1;
        end
            else if ( !switching_read_large_to_small0 && !switching_read_small_to_large0 ) begin
        end else begin
            rd_large0 <= #0.01 {1{1′bx}};
        end
    end
end
always @( posedge clk or negedge reset_{—} ) begin
    if ( !reset_{—} ) begin
        small0_used <= #0.01 3′d0;
        small0_reads_pending <= #0.01 3′d0;
        large0_used <= #0.01 5′d0;
        large0_reads_pending <= #0.01 5′d0;
    end else begin
        if ( switching_write_small_to_large0 ) begin
            small0_reads_pending <= #0.01 small0_used_next;
        end else if ( small0_reads_pending != 3′d0 && rd_popping0_small ) begin
            small0_reads_pending <= #0.01 small0_reads_pending − 3′d1;
        end
            else if ( !switching_write_small_to_large0 && !( small0_reads_pending != 3′d0 &&
rd_popping0_small ) ) begin
        end else begin
            small0_reads_pending <= #0.01 {3{1′bx}};
        end
        if ( switching_write_large_to_small0 ) begin
            large0_reads_pending <= #0.01 large0_used_next;
        end else if ( large0_reads_pending != 5′d0 && rd_popping0_large ) begin
            large0_reads_pending <= #0.01 large0_reads_pending − 5′d1;
        end
            else if ( !switching_write_large_to_small0 && !( large0_reads_pending != 5′d0 &&
rd_popping0_large ) ) begin
        end else begin
            large0_reads_pending <= #0.01 {5{1′bx}};
        end
        if ( wr_pushing0_small != rd_popping0_small ) begin
            small0_used <= #0.01 small0_used_next;
        end
            else if ( !( wr_pushing0_small != rd_popping0_small ) ) begin
        end else begin
            small0_used <= #0.01 {3{1′bx}};
        end
        if ( wr_pushing0_large != rd_popping0_large ) begin
            large0_used <= #0.01 large0_used_next;
        end
            else if ( !( wr_pushing0_large != rd_popping0_large ) ) begin
        end else begin
            large0_used <= #0.01 {5{1′bx}};
        end
    end
end
reg [2:0] small1_used; // small ram entries in use
reg [2:0] small1_reads_pending; // small ram entries remaining to be read when switching write
pointer to large ram
reg [4:0] large1_used; // large ram entries in use
reg [4:0] large1_reads_pending; // large ram entries remaining to be read when switching write
pointer to small ram
wire [2:0] small1_used_next = small1_used + wr_pushing1_small − rd_popping1_small;
wire [4:0] large1_used_next = large1_used + wr_pushing1_large − rd_popping1_large;
wire [2:0] small1_depth = small1_adr_max − small1_adr_min + 5′d1;
wire [4:0] large1_depth = large1_adr_max − large1_adr_min + 5′d1;
wire switching_write_large_to_small1 = wr_large1 &&
                                      ( small1_used_next == 3′d0 || // small ram
got empty - spill2 case
                                        ( small1_used_next != small1_depth && // small
ram not full
                                            ( large1_used_next == large1_depth || // large
ram got full
                                              large1_used_next == 5′d0 ) // large ram
got empty
                                        )
                                      );
wire switching_write_small_to_large1 = !wr_large1 &&
                                      small1_used_next == small1_depth && large1_used_next !=
large1_depth; // small ram got full
wire switching_read_large_to_small1 = rd_large1 &&
                                      ( large1_used_next == 5′d0 ||
                                      ( rd_popping1 && small1_reads_pending != 3′d0 &&
large1_reads_pending == 5′d1 ) ) ; // read out in write order
wire switching_read_small_to_large1 = !rd_large1 &&
                                      ( small1_used_next == 3′d0 && large1_used_next != 5′d0 ||
// small ram got empty
                                      ( rd_popping1 && small1_reads_pending == 3′d1 &&
large1_reads_pending != 5′d0 ) ); // read out in write order
assign rd_large1_next = !switching_read_large_to_small1 &&
                      ( switching_read_small_to_large1 || rd_large1 );
always @( posedge clk or negedge reset_{—} ) begin
    if ( !reset_{—} ) begin
        wr_large1 <= #0.01 1′b0;
        rd_large1 <= #0.01 1′b0;
    end else begin
        if ( switching_write_large_to_small1 ) begin
            wr_large1 <= #0.01 1′b0;
        end else if ( switching_write_small_to_large1 ) begin
            wr_large1 <= #0.01 1′b1;
        end
            else if ( !switching_write_large_to_small1 && !switching_write_small_to_large1 )
begin
        end else begin
            wr_large1 <= #0.01 {1{1′bx}};
        end
        if ( switching_read_large_to_small1 ) begin
            rd_large1 <= #0.01 1′b0;
        end else if ( switching_read_small_to_large1 ) begin
            rd_large1 <= #0.01 1′b1;
        end
            else if ( !switching_read_large_to_small1 && !switching_read_small_to_large1 ) begin
        end else begin
            rd_large1 <= #0.01 {1{1′bx}};
        end
    end
end
always @( posedge clk or negedge reset_{—} ) begin
    if ( !reset_{—} ) begin
        small1_used <= #0.01 3′d0;
        small1_reads_pending <= #0.01 3′d0;
        large1_used <= #0.01 5′d0;
        large1_reads_pending <= #0.01 5′d0;
    end else begin
        if ( switching_write_small_to_large1 ) begin
            small1_reads_pending <= #0.01 small1_used_next;
        end else if ( small1_reads_pending != 3′d0 && rd_popping1_small ) begin
            small1_reads_pending <= #0.01 small1_reads_pending − 3′d1;
        end
            else if ( !switching_write_small_to_large1 && !( small1_reads_pending != 3′d0 &&
rd_popping1_small ) ) begin
        end else begin
            small1_reads_pending <= #0.01 {3{1′bx}};
        end
        if ( switching_write_large_to_small1 ) begin
            large1_reads_pending <= #0.01 large1_used_next;
        end else if ( large1_reads_pending != 5′d0 && rd_popping1_large ) begin
            large1_reads_pending <= #0.01 large1_reads_pending − 5′d1;
        end
            else if ( !switching_write_large_to_small1 && !( large1_reads_pending != 5′d0 &&
rd_popping1_large ) ) begin
        end else begin
            large1_reads_pending <= #0.01 {5{1′bx}};
        end
        if ( wr_pushing1_small != rd_popping1_small ) begin
            small1_used <= #0.01 small1_used_next;
        end
            else if ( !( wr_pushing1_small != rd_popping1_small ) ) begin
        end else begin
            small1_used <= #0.01 {3{1′bx}};
        end
        if ( wr_pushing1_large != rd_popping1_large ) begin
            large1_used <= #0.01 large1_used_next;
        end
            else if ( !( wr_pushing1_large != rd_popping1_large ) ) begin
        end else begin
            large1_used <= #0.01 {5{1′bx}};
        end
    end
end
endmodule // test1_vsplit_ram_rws_32×8_v4
```

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A First-in First-out (FIFO) memory comprising:
an input configured to receive data to be buffered;
a first memory block comprising a plurality of sections, each comprising a plurality of sequential logic storage units and operable to buffer data for a respective execution thread of a plurality of execution threads;
a second memory block comprising a plurality of sections, each comprising a plurality of Random Access Memory (RAM) cells and operable to buffer data for a respective execution thread of said plurality of execution threads;
first logic coupled to, and configurable to control usage of, said first and said second memory blocks, wherein:
data for a respective execution thread are pushed into a corresponding section of said first memory block, if said corresponding section comprises vacancies until said corresponding section is full;
upon said corresponding section of said first memory block being full, pushing data for said respective execution thread to a corresponding section of said second memory block during a corresponding spill-over period until said corresponding section of said first memory block is empty and then using said corresponding section of said first memory block; and
data for said respective execution thread being buffered are drained in accordance with the entry order thereof; and
an output configured to drain data.

2. The FIFO memory as described in claim 1, wherein storage capacity assigned to a respective section of said first memory block and/or said second memory block is reconfigurable upon said FIFO memory being determined to be empty; wherein further said first memory block has less capacity than said second memory block; and wherein said sequential logic storage units comprise latches, flip-flops, or a combination thereof.

3. The FIFO memory as described in claim 1, wherein said first memory block comprises at least two latch arrays, each of said latch arrays comprising one or more sections; and wherein storage capacity assigned to each of said one or more sections is independent of user configuration.

4. The FIFO memory as described in claim 1, wherein said first logic is further configured to, upon said corresponding section of said second memory block being full before said corresponding section of said first memory becoming empty, push data for said respective execution thread into a spill region of said corresponding section of said first memory.

5. The FIFO memory as described in claim 1 wherein said first memory block is disposed near circuitry that uses data input to or output from said FIFO memory, and wherein said second memory block is disposed proximate to an integrated circuit peripheral.

6. The FIFO memory as described in claim 1 wherein said first memory block consumes less dynamic power and operates faster than said second memory block.

7. The FIFO memory as described in claim 1,
wherein a first section of said second memory block comprises a first spill region and a second spill region and is configured to buffer data for a first execution thread of said plurality of execution threads;
wherein further a first section of said first memory block is configured to buffer data for said first execution thread; and
wherein pushing data for said first execution thread to said first section of said second memory block during a corresponding spill-over period comprises:
pushing data for said first execution thread into said first spill region until said first section of said first memory block is empty; and
upon said first section of said first memory block being full and said first spill regions being not empty, pushing data into said second spill region until said first section of said first memory block is evaluated to be empty.

8. The FIFO memory as described in claim 7, wherein said second spill region merges with said first spill region upon said first spill region being empty.

9. The FIFO memory as described in claim 1 wherein said first and said second memory blocks are treated as a single FIFO storage entity by external circuitry.

10. A method of buffering data for multiple execution threads using a FIFO memory comprising:
a) buffering data for a first execution thread to and from a first segment of a first memory block while said first segment has vacancies;
b) upon said first segment of said first memory block becoming full, buffering data for said first execution thread to a first spill region of a first portion of a second memory block during a corresponding spill-over period;
c) during said corresponding spill-over period, buffering data for said first execution thread to said first spill region of said first portion of said second memory block until said first segment of said first memory block becoming empty; and
d) during said b) and said c) draining data for said first execution thread out of said first and second memory blocks in accordance with a storage order thereof.

11. The method as described in claim 10 further comprising buffering said data for said first execution thread to a second spill region of said second memory block during said corresponding spill-over period upon said first segment of said memory block being determined to be full and said first spill region being determined to be not empty.

12. The method as described in claim 11 wherein only one of said first spill region and said second spill region remains active to receive data for said first execution thread during said corresponding spill-over period.

13. The method as described in claim 11 further comprising merging said second spill region with said first spill region upon said first spill region being determined to be empty.

14. The method as described in claim 10 further comprising:
buffering data for a second execution thread to and from a spill region of a second segment of said first memory block while said second segment has vacancies;
upon said second segment of said first memory block being full, buffering data for said second execution thread to and from a first spill region of a second portion of said second memory block during another corresponding spill-over period; and
during said another corresponding spill-over period, buffering data for said second execution thread to and from said first spill region of said second portion of said second memory block upon said second segment of said first memory block becoming empty,
wherein said first and second spill regions of said second portion are dynamic partitions of said second memory block.

15. The method as described in claim 14 further comprising: while said first and said second memory block are determined to be empty, reconfiguring said first and said second segments of said first memory block; and reconfiguring said first and said second portions of said second memory block.

16. The method as described in claim 10 wherein data for said multiple execution threads are buffered through a single input and a single output of said FIFO memory.

17. A computer readable non-transient storage medium storing instructions for causing a processor to produce synthesizable code representing a FIFO memory by performing the operations of:
obtaining configuration input from a user;
generating a first portion of the synthesizable code representing an input operable to receive data to be buffered for a plurality of execution threads by said FIFO memory;
generating a second portion of the synthesizable code representing a first memory block comprising a plurality of memory segments, each of said plurality of memory segments comprising a plurality of latches and/or flip-flops;
generating a third portion of the synthesizable code representing a second memory block comprising a plurality of RAM sections, each of said RAM sections comprising a plurality of RAM cells;
generating a fourth portion of the synthesizable code representing logic coupled with and configurable to control usage of said first memory block and said second memory block, wherein said logic is operable to perform a method of:
a) buffering data for a respective execution thread to and from a respective memory segment of said first memory block while said respective memory segment has vacancies;
b) upon said respective memory segment of said first memory block becoming full, buffering data for said respective execution thread to and from a first spill region of a respective RAM section of said second memory block until said respective memory segment of said first memory block becoming empty or until said respective RAM section of said second memory block becomes full; and
c) draining data for said respective execution thread out of said first and second memory blocks in accordance with a storage order thereof.

18. A computer readable non-transient storage medium as described in claim 17, wherein said logic is further operable to perform buffering of data for said respective execution thread to a second spill region of said respective RAM section of said second memory block upon said respective memory segment of said first memory block becoming full and when said first spill region is not empty, and wherein only one of said first spill region and said second spill region of said respective RAM section remains active to receive data for said respective execution thread.

19. A computer readable non-transient storage medium as described in claim 18, wherein said second spill region merges with said first spill region upon said first spill region becoming empty.

20. A computer readable non-transient storage medium as described in claim 17, wherein said synthesizable code further lays down a RAM wrapper that resembles a normal RAM but transparently buffers data for said plurality of execution threads among said first and said second memory blocks.
